(19) United States
(12) Patent Application Publication
(10) Pub. No.: US 2003/0018755 A1
(43) Pub. Date: Jan. 23, 2003

(54) Online system that facilitates configuration and administration of residential electronic devices

(76) Inventors: Robert J. Masterson, Houston, TX (US); James P. Sauer, Houston, TX (US); Terry Koh, Houston, TX (US)

Correspondence Address: CONLEY ROSE & TAYON, P.C., P. O. BOX 3267, HOUSTON, TX, 77253-3267, US

(21) Appl. No.: 09/822,167

(22) Filed: Mar. 30, 2001

(51) Int. Cl. G06F 15/16; G06F 15/177; G06F 3/00

(52) U.S. Cl. 709/220; 709/203; 710/14

(57) ABSTRACT

In one embodiment, the online system comprises one or more servers coupled to the Internet and configured to provide an online configuration service. The service preferably includes maintaining a database of configuration information for registered electronic device, and providing a web page interface that allows owners of electronic devices to access and change the configuration information of their electronic devices. The electronic devices preferably initiate contact with the online system to synchronize their configuration information with the database. This web-based approach may advantageously provide electronic devices with a sophisticated (but inexpensive) graphical user interface, and may provide opportunities to businesses wishing to provide targeted advertising, direct sales of accessories, or subscription service sales to owners of electronic devices. Particular advantages may accrue to owners of digital audio recorders, alarm clocks, answering machines, audio electronics, multimedia electronics, home management systems, security systems, and sprinkler systems.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates generally to systems and methods for configuring and administrating electronic devices. More particularly, the present invention relates to an online system that facilitates such configuration and administration.

2. Description of Related Art

Technology has impacted nearly every aspect of our lives in ways most of us do not realize. One such example is consumer electronics. While many of us appreciate the entertainment potential offered by such devices as home stereo systems, television, video games, and video cassette recorders, we may take for granted the advantages provided by lights, alarm clocks, thermostats, and sprinkler systems. Consumer electronics form a major sector of the economy, and staggering amounts of money are spent each year by consumers wishing to acquire these devices. The strong demand for consumer electronics has stimulated competition and innovation in the consumer electronics arena. Many new products are introduced each year, and existing products are continually being improved. A particularly rich example of such advancement may be found in audio reproduction. Phonographs, record players, radios, tape recorders, compact disk players, magnetic disk players, and computers, have each been introduced and refined in numerous variations.

A recent introduction in the audio reproduction area is the digital audio recorder (DAR), sometimes called a “home stereo jukebox”. The DAR stores a large number of songs in digital format, for playback in any order. The newest version of the DAR stores songs in MP3 format on an internal hard disk drive. However, the DAR (and many other residential electronic devices) suffer from the lack of a practical user interface. A wealth of options and features are available, but unless the user adds a peripheral, these options and features can only be accessed through a small, front-panel display and a limited number of buttons. This makes configuration and day-to-day use of the product unnecessarily difficult.

A popular solution involves the use of a peripherals, such as a television screen and a keyboard. These peripherals are ordinarily too expensive and bulky to build into the product, so typically they are purchased separately. If the user employs a standard television screen, the size may be too large, and the resolution of the picture may be too poor, to provide a practical user interface.

### SUMMARY OF THE INVENTION

The problems outlined above are at least in part addressed by an online system that facilitates the configuration and administration of residential electronic devices. In one embodiment, the online system comprises one or more servers coupled to the Internet and configured to provide an online configuration service. The service preferably includes maintaining a database of configuration information for registered electronic device, and providing a web page interface that allows owners of electronic devices to access and change the configuration information of their electronic devices. The electronic devices preferably initiate contact with the online system to synchronize their configuration information with the database. This web-based approach may advantageously provide electronic devices with a sophisticated (but inexpensive) graphical user interface, and may provide opportunities to businesses wishing to provide targeted advertising, direct sales of accessories, or subscription service sales to owners of electronic devices. Particular advantages may accrue to owners of digital audio recorders, alarm clocks, answering machines, audio electronics, multimedia electronics, home management systems, security systems, and sprinkler systems.

### BRIEF DESCRIPTION OF THE DRAWINGS

For a more detailed description of the preferred embodiment of the present invention, reference will now be made to the accompanying drawings, wherein:

FIG. 1A shows a prior art personal computer;

FIG. 1B shows a representative block diagram of a personal computer;

FIG. 2 shows an illustrative digital audio recorder (DAR);

FIG. 3 illustrates a system that facilitates configuration of the DAR;

FIG. 4 shows a flow diagram of the synchronization process implemented by the DAR;

FIG. 5 shows a flow diagram of the synchronization process implemented by the server;

FIG. 6 shows a flow diagram of the configuration process implemented by the server;

FIG. 7 shows a flow diagram of the configuration process carried out by the user; and

FIG. 8 shows an illustrative configuration page.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENT

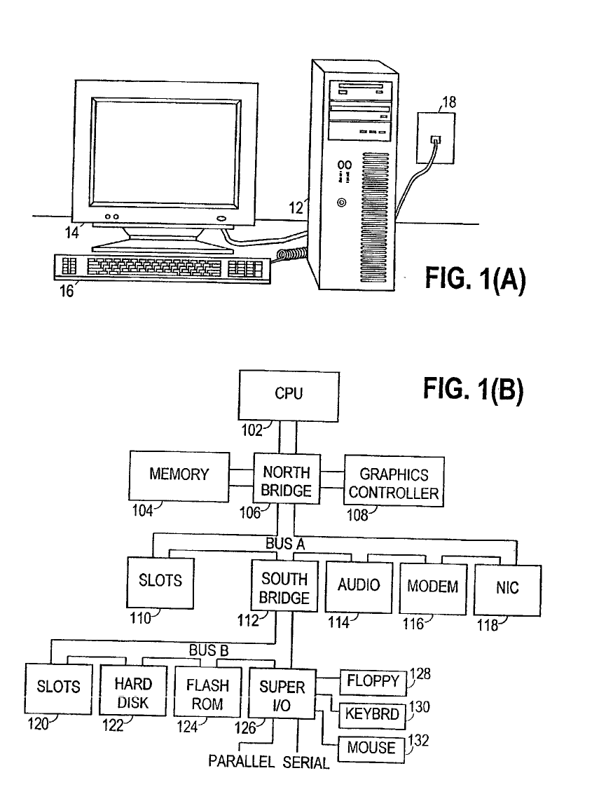

Turning now to the figures, FIG. 1A shows an exemplary computer system that a person can use to run software and access information on the Internet. Using the methods disclosed herein, such a computer may now be used to configure and administer the operation of residential electronic devices via an intermediate service provider.

In accordance with standard usage, a user can interact with the computer system via a user input device 16 and an output device 14 that are coupled to the computer 12. The computer 12 executes software stored internally or received from digital information communication media 18. Of course many variations exist for each of these components, and the particular configuration shown is not intended to exclude other configurations that are known in the art.

FIG. 1B shows an exemplary configuration of a representative prior art computer 12. Computer 12 typically includes a CPU 102 coupled to a bridge logic device 106 via a CPU bus. The bridge logic device 106 is sometimes referred to as a “North bridge” for no other reason than it often is depicted at the upper end of a computer system drawing. The North bridge 106 also couples to a main memory array 104 by a memory bus, and may further couple to a graphics controller 108 via an accelerated graphics port (AGP) bus. The graphics controller 108 generally drives a display monitor 14. The North bridge 106 couples CPU 102, memory 104, and graphics controller 108 to the other peripheral devices in the system through a primary expansion bus (BUS A) such as a PCI bus or an EISA bus. Various components that comply with the bus protocol of BUS A may reside on this bus, such as an audio device 114, a modem 116, and a network interface card (NIC) 118. These components may be integrated onto the motherboard, or they may be plugged into expansion slots 110 that are connected to BUS A. As technology evolves and higher-performance systems are increasingly sought, there is a greater tendency to integrate many of the devices into the motherboard which were previously separate plug-in components.

If other secondary expansion buses are provided in the computer system, as is typically the case, another bridge logic device 112 is used to couple the primary expansion bus (BUS A) to the secondary expansion bus (BUS B). This bridge logic 112 is sometimes referred to as a “South bridge” reflecting its location with respect to the North bridge 106 in a typical computer system drawing. Various components that comply with the bus protocol of BUS B may reside on this bus, such as hard disk controller 122, Flash ROM 124, and Super I/O controller 126. Slots 120 may also be provided for plug-in components that comply with the protocol of BUS B. The Super I/O controller 126 typically interfaces to basic input/output, devices such as a keyboard 130, a mouse 132, a floppy disk drive 128, a parallel port, a serial port, and sometimes various other input switches such as a power switch and a suspend switch.

Computer 12 may be coupled to a network or to the Internet via modem 116 or NIC 118. When coupled to the network, the user of computer 12 can access information stored on other computers. One way for a user to do this is to execute web-based software (e.g., a “browser”) on computer 12. Browser software is normally stored on internal long-term storage media such as hard disk 122. When the user initiates execution of the software, the processor 102 loads the software into memory 104, and then executes individual instructions from the software to control the various computer system components as needed to accomplish the desired web-browsing activities. The browser normally provides a graphical user interface (GUI) that graphically presents the user with a set of options on output device 14 (FIG. 1A), determines which, if any, of the available options that the user selects via input device 16, and responsively presents a new set of options in accordance with the user's selection.

Conventional browsers present the user options in the form of a web page. The browser can retrieve the web page from computer 12 or from other computers coupled to the network. Web pages are typically written in hyper-text markup language (HTML), a programming language that allows programmers to present options in the form of “links” from graphics or textual items within a page to other pages having new options in similar form. Some web pages include embedded software “applets” that the browsers can execute to accept text input, perform calculations, animate objects on the screen, generate customized web-pages, and/or send information to other computers.

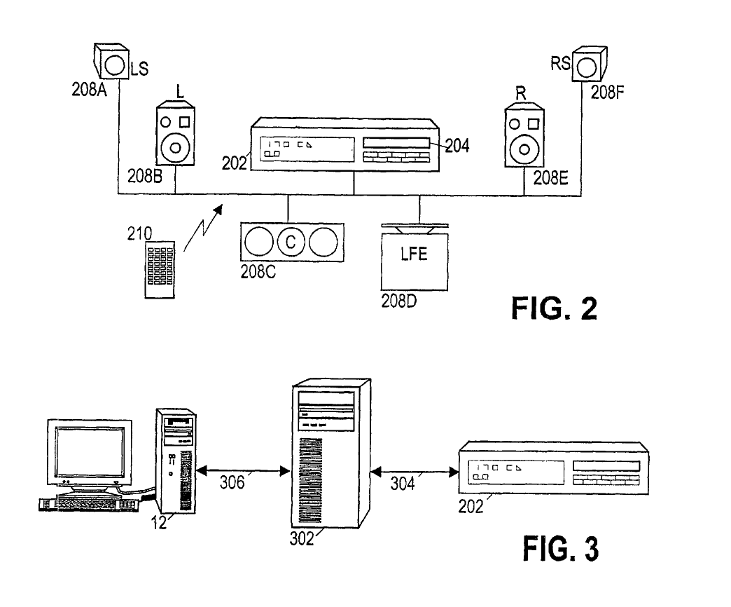

FIG. 2 shows a DAR 202 having a loading door for musical media (e.g. compact disks), and a remote control 210. The DAR 202 is shown coupled to a surround sound speaker set 208 having left (L) and right (R) speakers, left surround (LS) and right surround (RS) speakers, a center (C) speaker, and a low-frequency effects (LFE) speaker. The DAR may be used alone or as part of a stereo system or home entertainment system. Musical media placed into the DAR may be copied onto the internal disk, or simply played without copying. The user controls the playback of stored songs via remote control 210 or buttons on the front panel of the DAR.

The DAR may typically be able to store hundreds and perhaps thousands of songs, which can be variously grouped into one or more playlists, assigned different random playback probabilities, and indexed by artist, album, and genre. The compression and playback quality of each song may be individually tailored, digital processing effects (e.g. stadium, theatre, bandstand) may be chosen, and many other settings and parameters may be customized.

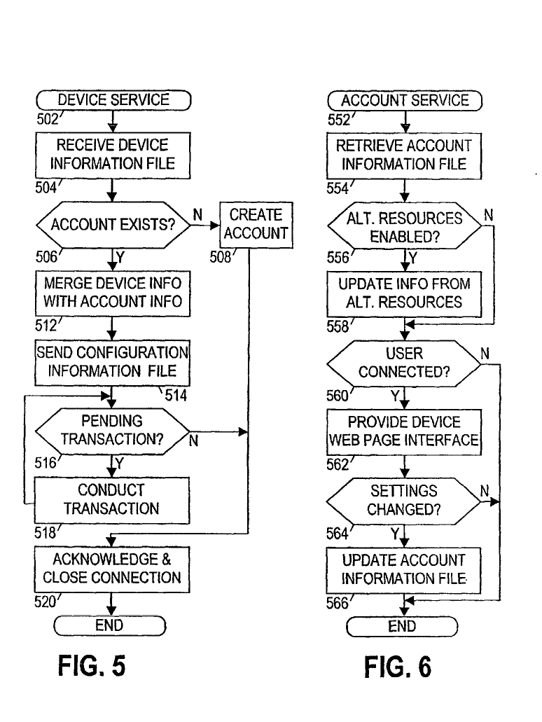

FIG. 3 shows a system that facilitates the configuration and administration of residential electronic devices such as the DAR. A server 302 provides an online service that allows a user to set up (i.e. configure) an electronic device 202 and to perform day-to-day control operations (i.e. administration) of the electronic device. The user can access the online service via any web-compatible system 12 that allows access to the server 302 via the Internet. The server 302 maintains a database of device configuration information that the user can access and alter, and the device 202 preferably accesses the server 302 periodically to retrieve any changes.

The device 202 preferably connects to the server 302 using a standard connection 304 such as a phone line or network cable. The device 202 may dial a phone number to connect to a default server or default Internet access provider, and may then use standard communication protocols to interact with server 302. Alternatively, the device 202 may connect to the user's Internet access provider, provide any necessary log in information, and then use standard communication protocols to interact with the server 302. Yet another alternative is for the device 202 to be coupled to a network having an “always-on” connection to the Internet. The device 202 may in this circumstance simply interact with the server 302 using standard communication protocols.

In each case, the connection 304 is preferably initiated periodically by the device 202. The preferred connection frequency is about once a day, preferably in the early hours of the morning. In addition, the user is preferably able to instruct the device 202 by an appropriate button press or menu item selection to initiate an “immediate” connection

The web-compatible system 12 couples to the server 302 by connection 306 at the user's instigation. Connection 306 is preferably a standard Internet connection that permits the user to retrieve web pages from server 302 and permits the user to submit form-based information to the server 302.

Server 302 provides an online Device Configuration and Administration (DCA) service for compatible residential electronic devices. It maintains a database of configuration information for each registered device, and it allows device owners to interact with the database via a web-based interface. The server 302 provides access to a set of stored web-page templates and applets that provide the interface, and system 12 retrieves the interface pages using standard browser software. The device 202 may provide and retrieve configuration data to and from the database in a customized format, including binary format, fixed-field text format, comma-delimited text format, and XML format, among others. The format is preferably one that minimizes hardware complexity of device 202.

The above description illustrates the interaction of the hardware involved in an example of an online system. However, the hardware configuration is merely the backdrop for the implementation of the online DCA system. To the user, and indeed, to the device 202, the hardware configuration is invisible. A wide variety of hardware configurations may be used to achieve essentially the same results. Each of the tasks may be distributed across several computers or congregated onto one.

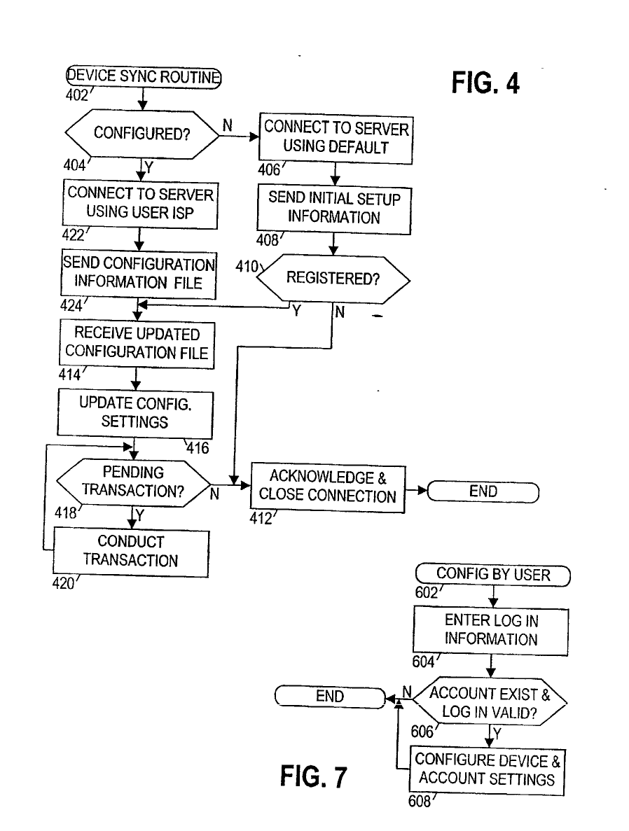

FIG. 4 shows an illustrative embodiment of a synchronization process 402 carried out by the residential electronic device. The process 402 may be initiated by the user, or may be automatically initiated periodically. Other system events (e.g. power-on, reset, transaction request) may also initiate the synchronization process 402.

The synchronization process begins with a configuration check in block 404. If a configuration error is detected, or if the system has not yet been configured, then in block 406 the device 202 connects to the server 302 using a default connection method. The default connection method is preferably a toll-free phone number maintained by the providers of the DCA service. If the device is coupled to a phone line, the device connects via modem to the toll-free phone number. After establishing a connection, in block 408 the device sends initial setup information to server 302. The initial set-up information may simply be device identifier and a serial number. Preferably, some form of security is provided via challenge/response encryption technology that allow the server 302 to verify the identity of the device 202. The device 202 may also provide an initial user password to server 302.

In block 410, the device 410 asks the server 302 if the server has an existing account for device 202. If not, the device 202 acknowledges the server response and closes the connection in block 412. If so, then in block 414, the device 202 retrieves from its account the latest configuration file. In block 416, the device 202 updates its configuration settings to reflect the received configuration information.

In block 418, the device 202 determines if there are any pending transactions. Examples of transactions include a purchase and/or a download of information. In the context of the DAR, the user may initiate a purchase of a song or an album on the device 202. The device 202 begins the synchronization process 402, and when it reaches block 420, the device notifies the server 302 that the user has requested a purchase, and identifies the item to be purchased. The server 302 carries out the purchasing process and, if successful, downloads the purchased item to device 202. After the purchases and downloads have been concluded, the device closes the connection in block 412.

Returning to block 404, if the device if properly configured, then in block 422, the device connects to the server using the programmed connection method. Preferably, this connection is made via the user's internet service provider (ISP). In block 424, the device 202 preferably sends a file containing the current configuration information to server 302. At the very least, the device preferably sends the device identifier and serial number, along with any desired security information. Other configuration information may be omitted if the user has not altered the configuration information on the device 202 since the last synchronization. The server combines the configuration information received from the device with the configuration information stored in the account. Since the configuration information may be altered both directly on the device and through the online service, the server 302 gives priority to the configuration changes most recently made if conflicting changes are made. In block 414 the server sends the updated configuration file to the device 202.

FIG. 5 shows an illustrative embodiment of the device servicing process 502 carried out by the server 302. This process is initiated when the device connects to the server. In block 504, the server 302 receives an information file from the device 202. The file preferably includes at least a device identifier and serial number, and may also include security information, a proposed user password, and various configuration values and state indications of the device. In block 506, the server 302 determines if an account has been established for the device. If no account exists, the server 302 creates an account in block 508, using the information received from the device. In block 520, the server closes the connection with the device.

If an account does exist, then in block 512, the server 302 combines the information received from the device with the account information, resolving any conflicts by giving priority to the change most recently made. The server then uses the updated account to generate and send a configuration information file to the device in block 514. In block 516, the server determines if the device has a pending transaction, and if so, attempts to carry out the transaction in block 518. Once all transactions have been concluded (either successfully or not), the server closes the connection with the device in block 520.

FIG. 6 shows an illustrative embodiment of the account servicing process 552. This process is initiated whenever the user connects to the server, and may also be automatically initiated periodically. In block 554, the server retrieves the account information, and in block 556, the server checks to determine if an alternate resources are enabled. Examples of alternate resources may include news subscriptions, weather, personalized traffic information, stocks, financial portfolio information, and so on. Such resources are generally available through third-party online services. If such resources are enabled, in block 558, the server obtains the appropriate information from the appropriate services, and updates the account information accordingly. Such information may be made available for download to device 202 during the next synchronization. Alternatively, the information may be processed by the server 302 to alter the configuration information of the device 202. Further discussion of the alternate resources is made at the conclusion of the detailed description.

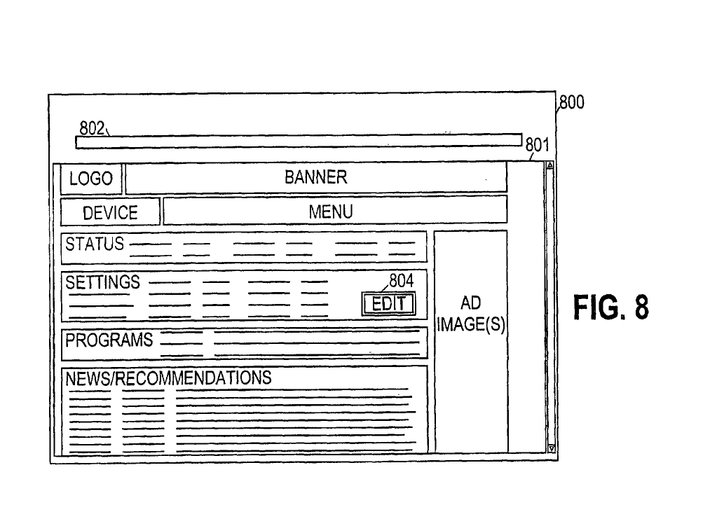

After the alternate resource updates, if any, the server 302 checks in block 560 to determine if the account servicing process 552 was initiated by the user. If not, the process completes. Otherwise, in block 562, the server 302 provides a web page interface to the user. One interface implementation is described below in reference to FIG. 8. If the user changes any settings in block 564, then the account is updated accordingly in block 566.

FIG. 7 illustrates the configuration process 602 from the user's perspective. In block 604, the user enters log in information in an initial log-in page provided by server 302. The first time a user connects, the user may be required to type in the device identifier, the serial number, and an initial password. The initial password may be randomly generated by the device and communicated to the user via a front-panel display. Alternatively, the initial password may be provided with the instructional materials enclosed with the device. The device 202 will have already communicated this information to the server 302 when the device was first plugged in. The device 202 may also have a reset function that re-initializes the account on the server.

During the first log-in, the user may be given the opportunity to choose a username and password. Thereafter, the username and password may be sufficient to allow the user access.

In block 606, the server determines if the account exists and the log in information is valid. If so, the user is allowed to configure the device settings in block 608.

FIG. 8 shows an illustrative web page that the server 302 may provide to system 12 as part of the user interface. System 12 executes browser software that provides a graphical user interface 800 that includes a display window 801 and a uniform resource locator (URL) entry box 802. The display window 801 shows a web page. By default, the URL entry box 802 shows the URL address of the web page being shown in window 801. However, the browser allows a user to enter a new URL address in box 802, and after the user presses the “Enter” key, the browser will attempt to retrieve a web page from a server having the specified address to display in window 801.

In FIG. 8, the display window 801 shows an illustrative “home page” for the device 202. Note that the web page presentation allows for a much more detailed and comprehensive presentation of configuration information than would be possible on a front panel display or normal television screen. In the illustrative embodiment, the home page includes a logo, a banner, a device title, a menu, a status section, a settings section, a programs section, a news and recommendations section, and an advertising section.

The logo may be text and/or an image that serves to identify the providers of the online configuration service. The banner may be an advertising area, a welcoming message, a top-level menu, or a description of the configuration service. The device title is preferably text and/or and image indicative of the product that the user owns. e.g. “BrandName Digital Audio Recorder Model 1324”. The menu is preferably a set of links for various user options, and may include such items as: “configure home page”, “change account settings”, “edit device configuration”, “edit programs”, “subscribe to alternate resources”, and “help”.

The status section preferably indicates the device status as of the last synchronization. In the context of a DAR, the status may include such statistics as “operational hours”, “available space”, “number of songs stored”, and “number of play lists programmed”. The settings section preferably indicates the values of various programmable configuration parameters, and may also include a button icon 804 for editing the values online. In the context of a DAR, the settings may include such items as “playing mode”, “dynamic range compression”, “sound effects filters”, “frequency band equalization gain”, and “transition effect”.

The programs section preferably indicates available groups of configuration settings. For a DAR, these could be previously programmed configurations, or alternatively, these could be programmed sequences of songs to play. These may include items labeled “Dance Party”, “Jazz”, “Romance”, and “Classical”.

The news and recommendations preferably indicates articles that may be of interest to the user. The server 302 may identify characteristics of the device configuration as indicative of a potential interest in, for example, a certain type of music. The server could then present news and recommendations relating to that type of music to the user. The articles may be presented as a list of article titles, and the user may view the contents of the article by clicking on the corresponding article. The advertising section may similarly present targeted advertising to the user. For example, if a new album has been released by an artist in the user's collection, the advertising section may present the user with an opportunity to purchase the new album. Such a purchase could be automatically downloaded to the device during the next synchronization.

In addition to performing an initial configuration of the device 202, the server 302 may be used to perform day-to-day changes of the configuration settings and to perform advanced programming of the device. The server may also service transaction requests from the device, and make automatic changes to the configuration of the device based on user account settings.

In the foregoing, the illustrative example for the device has been a DAR. However, the device may be any electronic device intended for residential use. The presently described system may be particularly useful for alarm clocks, audio electronics, multimedia electronics, home management systems, security systems, and sprinkler systems, just to name a few. Furthermore, the presently described system may also be particularly useful for “white goods.” White goods are home appliances including, but not limited to, refrigerators, dishwashers, microwaves, washers and dryers. Of course, the user may own multiple devices and may associate each of the devices with his user account on the configuration server.

As mentioned previously, the alternate resources may include such resources as news subscriptions, weather, personalized traffic information, stocks, and financial portfolio information. The server may use these resources to generate audio reports for download to the DAR and periodic playback between songs. T he server may also process the data and adjust configuration of other devices. For example, the server may cancel a program on the sprinkler system if the weather forecast calls for rain. The server may advance the alarm clock's wake-up time if the traffic report indicates excessive congestion on the user's commute. The server may automatically program a recording command for a VCR based on television listings and the user's programmed preferences. In each of these examples, the device's programming would be automatically updated the next time it synchronizes itself with the server.

Numerous variations and modifications will become apparent to those skilled in the art once the above disclosure is filly appreciated. It is intended that the following claims be interpreted to embrace all such variations and modifications.

What is claimed is:

1. A method of configuring an electronic device, wherein the method comprises:
receiving device configuration information from a user;
storing the device configuration information into an online database; and
providing device configuration information from the database to the electronic device.

2. The method of claim 1, wherein the electronic device is designed for residential use.

3. The method of claim 1, wherein the electronic device is a digital audio recorder.

4. The method of claim 1, wherein the electronic device is one of a set consisting of: alarm clocks, answering machines, audio electronics, multimedia electronics, home management systems, security systems, and sprinkler systems.

5. The method of claim 1, wherein the electronic device is a white good.

6. The method of claim 1, wherein said act of providing device configuration information to the electronic device is performed in response to:
receiving a synchronization request from the electronic device.

7. The method of claim 6, wherein the synchronization request includes a serial number of the electronic device.

8. The method of claim 7, wherein the synchronization request further includes an indication of whether any configuration changes have been made on the electronic device since a previous synchronization.

9. The method of claim 7, wherein the synchronization request further includes any configuration changes that have been made on the electronic device since a previous synchronization.

10. The method of claim 9, further comprising:
after receiving any configuration changes from the electronic device, updating the configuration information of the device in the database.

11. The method of claim 10, wherein if any configuration changes from the electronic device conflict with configuration information provided by the user since the previous synchronization, priority is given to whichever changes were most recently made.

12. The method of claim 1, further comprising:
periodically servicing an account associated with the electronic device, wherein the servicing includes:
determining if alternate resources are enabled, and if so, updating the device configuration information in the online database in accordance with information obtained from the alternate resources.

13. The method of claim 12, wherein the alternate resources include one of the set consisting of: news subscriptions, weather, personalized traffic information, financial markets, financial portfolio information, and television listings.

14. The method of claim 12, wherein said act of updating the device configuration information includes changing a configuration value previously set by the user.

15. The method of claim 14, wherein the configuration value is a wakeup time.

16. The method of claim 1, wherein the device configuration information includes song playlists.

17. The method of claim 1, further comprising:
before said act of receiving device configuration information from the user,
receiving an initial communication from the electronic device; and
creating an account in the online database associated with the electronic device.

18. The method of claim 17, wherein the initial communication includes a device serial number.

19. The method of claim 18, wherein the initial communication further includes an initial password.

20. A device configuration system that comprises:
a network;
one or more servers coupled to the network and configured to provide an online service,
wherein the service includes:
providing a web page interface featuring a home page for an electronic device owned by a user;
receiving device configuration information from the user via the interface;
storing the device configuration information into an online database; and
providing device configuration information from the database to the electronic device.

21. The system of claim 20, wherein the electronic device is a digital audio recorder.

22. The system of claim 20, wherein the electronic device is one of a set consisting of: alarm clocks, answering machines, audio electronics, multimedia electronics, home management systems, security systems, and sprinkler systems.

23. The system of claim 20, wherein said providing device configuration information to the electronic device is performed in response to:
receiving a synchronization request from the electronic device.

24. The system of claim 23, wherein the synchronization request includes a serial number of the electronic device.

25. The system of claim 24, wherein the synchronization request further includes any configuration changes that have been made on the electronic device since a previous synchronization.

26. The system of claim 20, wherein the service further includes:
periodically servicing an account associated with the electronic device, wherein the servicing includes:
determining if alternate resources are enabled, and if so, updating the device configuration information in the online database in accordance with information obtained from the alternate resources.

27. The system of claim 26, wherein the alternate resources include one of the set consisting of: news subscriptions, weather, personalized traffic information, financial markets, financial portfolio information, and television listings.

28. The system of claim 26, wherein said updating the device configuration information includes changing a configuration value previously set by the user.

29. The system of claim 28, wherein the configuration value is a wakeup time.

30. The system of claim 20, wherein the device configuration information includes song playlists.

31. The system of claim 20, wherein the service further includes:
before said receiving device configuration information from the user,
receiving an initial communication from the electronic device; and
creating an account in the online database associated with the electronic device.

32. The system of claim 31, wherein the initial communication includes a device serial number.

33. The system of claim 31, wherein the initial communication further includes an initial password generated by the electronic device.
